(19) United States
(12) Patent Application Publication
(10) Pub. No.: US 2009/0044607 A1
(43) Pub. Date: Feb. 19, 2009

(54) METHOD AND DEVICE FOR DRAWING A VOLUME OF LIQUID BY SUCTION, IN PARTICULAR FOR COLLECTING A SAMPLE FOR ANALYSIS BY MEANS OF A LIQUID CHROMATOGRAPHY DEVICE

(76) Inventors: Hermann Hochgraeber, Offenburg-Neuhausen (DE); Michael Hene, Munchen (DE)

Correspondence Address: THE CULBERTSON GROUP, P.C., 1114 LOST CREEK BLVD., SUITE 420, AUSTIN, TX, 78746, US

(21) Appl. No.: 12/279,686

(22) PCT Filed: Feb. 2, 2007
(86) PCT No.: PCT/DE2007/000190

§ 371 Date: Aug. 15, 2008

(30) Foreign Application Priority Data
Feb. 16, 2006 (DE) 10 2006007542.01

(51) Int. Cl. G01N 30/18

(52) U.S. Cl. 73/61.55

(57) ABSTRACT

The invention relates to a method for drawing a liquid volume, in particular for drawing a sample for analysis by means of a liquid chromatography device, wherein the liquid comprising the liquid volume to be withdrawn is provided in a container 7, 75 that is closed off by means of a closure 72, 71; 76, 761, which consists at least in a partial area of a flexible material that can be penetrated by means of sampling needle, wherein for the withdrawal of a defined liquid volume, sampling needle 6 is punched through the partial area consisting of flexible material, until the suction opening of the sampling needle is immersed sufficiently in the liquid, and wherein a defined liquid volume is withdrawn. In order to prevent a negative pressure from arising in container 7, 75 due to the removal of liquid volume, a relative movement between sampling needle 6 and container 7, 75 is produced according to the invention in a direction substantially perpendicular to the longitudinal axis of sampling needle 6 in such a manner that the opening 9 produced in the flexible material of closure 72, 71; 76, 761 by the puncturing of the flexible material is expanded in such a manner that a complete or partial pressure equalization between the container volume and the surroundings is made possible between the outer wall of sampling needle 6 and the inner wall of expanded opening 9.

The invention relates to a method with the characteristics of the preamble of Claim 1 for drawing a volume of liquid by suction, in particular for collecting a sample for analysis by means of a liquid chromatography device. The invention further relates to a device according to Claim 6 for performing the method.

The invention has particular importance for the field of liquid chromatography and, more particularly, for the field of high-performance liquid chromatography (HPLC). In HPLC, a mixture of substances is separated in a chromatographic column into its components so that they can be analyzed or further processed. For the automated analysis of a number of samples, which must be available in liquid or dissolved form for liquid chromatography, autosamplers are used that pick up the samples, i.e., a defined volume of liquid, one after the other from a number of sample containers and supply them in that order to the analysis system. Such autosamplers are known, for instance, from U.S. Pat. Nos. 4,242,909 and 4,713,974.

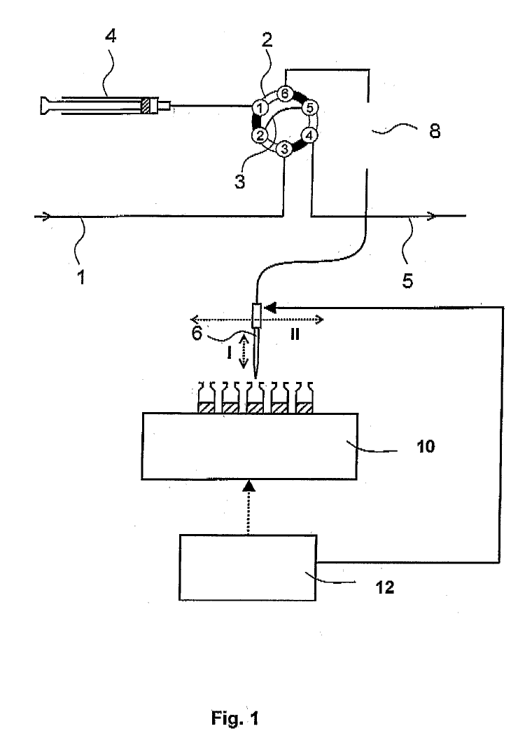

The basic mode of operation of such autosamplers will be described below on the basis of an example, since it is important for understanding the invention. FIG. 1 shows a schematic representation of the essential components of a known autosampler.

A liquid stream supplied by a pump (not shown) reaches the autosampler through an input capillary 1, passes a six-port transfer valve 2 and leaves the autosampler via an output capillary 5. The samples to be analyzed are situated in sample containers 7, and can be collected therefrom by a sampling needle or sample needle 6. To receive and fix the sample containers 7 in respectively defined positions, a schematically illustrated receiving unit 10 for the sample containers 7 is provided. The receiving unit can comprise a drive mechanism for positioning the individual sample containers 7 relative to sampling needle 6 in a plane substantially perpendicular to the longitudinal axis of sampling needle 6 as well as a mechanism suitable therefor. This alternative is indicated in FIG. 1 by the arrow in dashed lines between a control unit 12 for controlling the drive mechanism of receiving unit 10. As illustrated in FIG. 1, control unit 12 can also control a drive mechanism, not shown in detail, for axial positioning of sampling needle 6 in order to allow an axial relative movement between sample containers 7 and sampling needle 6. The relative movements between sample containers 7, or receiving unit 10, and sampling needle 6 in the direction of the longitudinal axis of sampling needle 6 and in a plane (or direction) substantially perpendicular thereto that can be realized by these two drive mechanisms are indicated in FIG. 1 by arrows I and II. Thus, sampling needle 6 can first be positioned above any desired sample container 7 and then be dipped or punched into it in order to collect the respective sample. The relative movements between receiving unit 10 and sampling needle 6 can also be realized in such a manner that only sampling needle 6 or only receiving unit 10 is movable by means of suitable controllable drive mechanisms in the axial direction and in the plane perpendicular thereto. In each case, at least two axes of motion are required in order to travel to multiple sample containers 7 and dip sampling needle 6 into them.

Transfer valve 2 has two switching positions: the position shown in FIG. 1 is referred to below as position 1-2; port 1 is connected to 2, 3 to 4, and 5 to 6. The second position is referred to as position 1-6, wherein port 2 is connected to 3, 4 to 5, and 6 to 1. In position 1-2, input capillary 1 is directly connected to output capillary 5. Furthermore, metering syringe 4, sample loop 3, connection capillary 8 and sampling needle 6 are connected in series.

At first, transfer valve 2 is in position 6-1, i.e., a metering syringe 4 is connected to sampling needle 6 directly above connection capillary 8. The liquid stream arriving via input capillary 1 is conducted via a sample loop 3 to an output capillary 5. While sampling needle 6 dips into a sample container 7, a defined volume of fluid can be collected from the respective sample container 7 by suctioning by means of metering syringe 4, which can likewise be constructed to be controllable by control unit 12. This liquid volume can be withdrawn by connection capillary 8 sufficiently that it reaches transfer valve 2. Then transfer valve 2 is switched to position 1-2, so that sample loop 3 is situated in the path between metering syringe 4 and connection capillary 8. By further withdrawal with the metering syringe, a precisely predetermined amount of sample can be drawn into sample loop 3. By switching transfer valve 2 into position 6-1, sample loop 3 is again shifted into the path between input capillary 1 and output capillary 5, so that the sample material is inserted into the liquid stream and leaves the sample via output capillary 5.

The insertion of the sample into the liquid stream is referred to as injection. The samples to be investigated can be injected in any desired sequence in the manner just described.

The fundamental operating mode of autosamplers from prior art corresponds in most cases to the above-described basic principle. There are different variants derived from this principle in prior art, in which, for example, the sampling needle and an associated needle seat are components of the sample loop. This allows a thriftier handling of sample liquid. An extensive presentation of the numerous variants of this type will be omitted. The present invention can be applied accordingly to these variants, however.

If one uses open sample containers as shown in FIG. 1, evaporation of sample material or solvent occurs. Sample material and/or solvent is thereby lost, and the concentration of the samples in the solution is changed. Moreover, there can be undesired changes (e.g., oxidation) or contamination of the samples due to the contact between ambient air and samples. Therefore, closed sample containers are used in many cases.

The closure generally consists of a soft elastic material and is referred to as a septum. Such a closure is described in U.S. Pat. No. 6,752,965, for example, and has the advantage that it can easily be penetrated by sampling needle 6 to take a sample, and then to a large extent reseal itself. An expensive mechanism for opening and closing the sample container can thereby be eliminated.

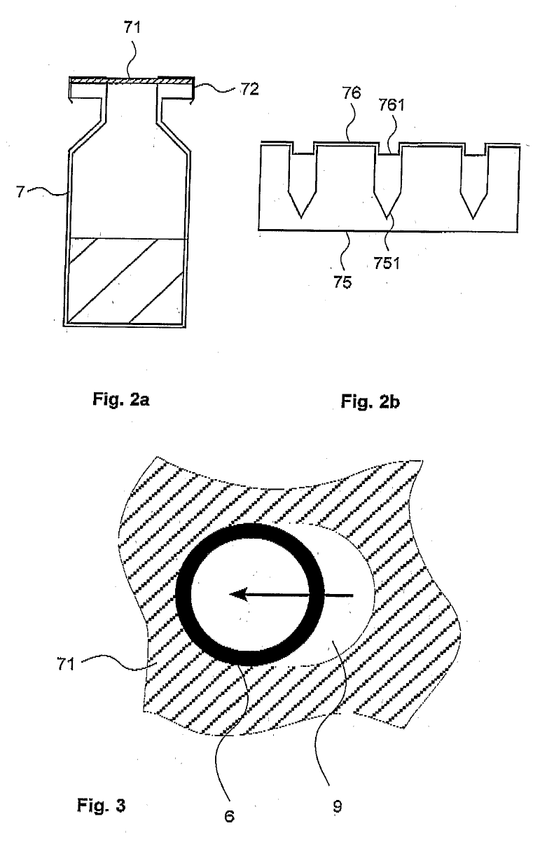

FIG. 2 shows two examples of such closed sample containers. An individual sample container 7 for holding a single sample fluid is shown in FIG. 2a. Several such individual sample containers 7 can be held in defined positions in a receiving unit 10 according to FIG. 1.

In an individual sample container 7 according to FIG. 2a, a septum 71 is retained by a cap 72 having a passage opening in the center which leaves septum 71 untouched. Septum 71 can therefore be penetrated by sampling needle 6 in the area of the passage opening of cap 72.

Alternatively, multiple sample containers 75 according to FIG. 2b, so-called well plates, are being increasingly used, in which depressions (so-called wells) 751 are provided for receiving the individual sample fluids. The closure is produced in this case via a bubble sheet or bubble plate 76, the bubbles 761 of which are each pushed into a depression 751 and close off the opening of the respective depression. The advantage of using well plates and bubble sheets is that a large number of sample fluids can be accommodated in a small space and it is not necessary to handle individual sample containers.

Both septum 71 and bubble sheet 76 consist of an elastic material.

To collect samples, sampling needle 6 penetrates septum 7 or the respective bubble 761. The elastic material is constructed in such a way that sampling needle 6 is enclosed substantially tightly as long as it is in sampling container 7 or in a depression 751. During the suction process therefore, no ambient air can flow in to replace the volume of the sample that was removed, i.e., a negative pressure is formed in the sampling container. This is greater the more the sampling container was filled initially, or the smaller the enclosed gas volume was and the more sampling fluid that was withdrawn.

Since a certain amount of gases, e.g., atmospheric oxygen, is dissolved in the sample fluid, as a rule, gas bubbles can form due to the negative pressure. Moreover, the boiling point of the sample fluid is lowered due to the negative pressure, so that, particularly for a highly volatile solvent, boiling of the sample liquid can occur. Because the negative pressure affects the entire suction system, these effects can appear in sample container 7 or 75 as well as in metering syringe 4, transfer valve 2, sample loop 3, connection capillary 8 or sampling needle 6.

The formation of gas bubbles has the effect in every case that the sample volume actually withdrawn is markedly reduced. When the sampling needle leaves the sample container, a pressure equalization also occurs, i.e., gas bubbles created in the suction path contract and air flows in.

Both of these lead to non-reproducible or erroneous analysis results. For this reason, the formation of gas bubbles must be avoided under all circumstances.

Countering the formation of a negative pressure by using significantly larger sample containers than are actually necessary is known. These are then filled only to the extent that the remaining volume (gas volume) is much greater than the fluid volume to be withdrawn. A gas volume that relaxes during the process of suctioning the sample volume, and thus counteracts the creation of negative pressure, is then situated above the sample fluid.

Another solution according to prior art is to markedly reduce the withdrawal speed during sampling. In that way, the risk of gas bubble formation is greatly reduced because air can flow in through the still-present small unsealed areas between the needle and the septum or between the septum and the sample container.

These solutions according to prior art resulted in practical disadvantages, since either larger sample containers must be used and therefore fewer containers can be accommodated per unit area, or the withdrawal speed must be sharply reduced so that the withdrawal process lasts a very long time and the system becomes correspondingly lower in performance. Moreover, the problem is only partially solved in this manner, since the negative pressure nevertheless arises, even if to a lesser extent.

Solutions are also known in which a pressure equalization is made possible by a special design of the sampling needle. In these solutions, either an additional ventilation channel is contained in the sampling needle, or the sampling needle is formed such that the entry of air is allowed at the point at which the sampling needle penetrates the septum.

These solutions require a thicker sampling needle with a complicated shape. In addition to the increased expense, this also results in practical disadvantages, since higher forces are now required in order to penetrate the septum, which leads to considerably greater wear and tear on the septum. Furthermore, it is very difficult to rid such needles of adhering sample residues, which can then lead to a falsification of the analysis results for subsequent samples.

The problem of the present invention is therefore to create a method for drawing a liquid volume, in particular for collecting a sample for analysis by means of a liquid chromatography device, in which the creation of a negative pressure in the sampling container during the sample withdrawal is avoided, without having to accept limitations with respect to the fill level of the sampling containers, the amount of sample withdrawn or the withdrawal rate. Simultaneously, the solution according to the invention should not have any undesired side effects such as increased wear of the septa or intensified sample entrainment. The invention is further based on the problem of creating a device for performing the method.

The problem is solved with the characteristics of claims 1 and 6.

The invention proceeds from the recognition that a significant negative pressure cannot arise at all in the sample container if the entry of air into the sample container is allowed during the withdrawal process. The invention is further based on the consideration that the sealing effect of the septum during the withdrawal of a sample is based on its elasticity and that this elasticity can be used temporarily to suspend the sealing effect and enable a pressure equalization between the interior of the sample container and the surroundings.

By moving the sampling needle and the sample container by a slight amount after penetration of the flexible material (the septum), i.e., while the sampling needle is in the sample container, the hole in the septum is somewhat widened by the sampling needle, given a suitable selection of the movement. This has the effect that air can enter the sample container alongside the sampling needle, and thereby an equalization of pressure takes place. Consequently, the withdrawal of even large volumes no longer leads to the formation of a negative pressure, and the formation of gas bubbles is avoided.

According to one embodiment of the invention, the container and the sampling needle are moved relative to one another in a direction substantially perpendicular to the longitudinal axis of the sampling needle. For known autosamplers, such a movement can be realized with the already available hardware. For an implementation, the controller of the drive mechanism or mechanisms need only be adapted, which is largely possible with simple software or firmware modifications.

According to one embodiment of the invention, the pressure equalization due to the performance of the relative movement becomes possible only if a predetermined threshold value for the absolute value of the pressure difference between the container volume and the surroundings is present or is detected.

For instance, the pressure equalization due to the performance of the relative movement can be enabled only after a predetermined span of time following the start of the withdrawal, or after the withdrawal of a predetermined partial volume.

Initially a volume diminution of the container's interior can be effected in the penetration of the flexible material by virtue of the fact that the flexible material first bulges inwardly due to the piercing process, and the pressure equalization due to the performance of the relative movement is effected only if a partial volume corresponding to the volume diminution has been withdrawn.

A device according to the invention for drawing a volume of liquid, in particular for collecting a sample and supplying it to a liquid chromatography device, may be distinguished from known devices only in that the control unit for controlling the drive mechanism or mechanisms for moving the sampling needle and/or the receiving unit for the sample container or containers is constructed such that a relative movement between receiving unit and sampling needle after puncturing can be performed in such a manner that a pressure equalization is enabled between the container's interior and the surroundings.

If the control unit has a microprocessor circuit, as is customary in practice, the solution according to the present invention can be integrated into an already existing device in a simple and economic manner as part of a software or firmware modification.

Additional embodiments of the invention follow from the subordinate claims.

The invention will be explained in detail below with reference to the figures represented in the drawings. In the drawings:

FIG. 1 shows a schematic representation of the components essential to the invention in an autosampler for a liquid chromatography device;

FIG. 2 shows a schematic representation of an individual sample container (FIG. 2a) and of a multiple sample container (FIG. 2b) for liquid chromatography;

FIG. 3 shows a schematic cross section through a sampling needle penetrating a septum;

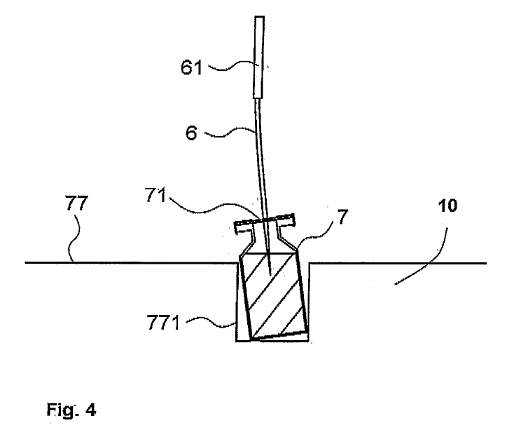

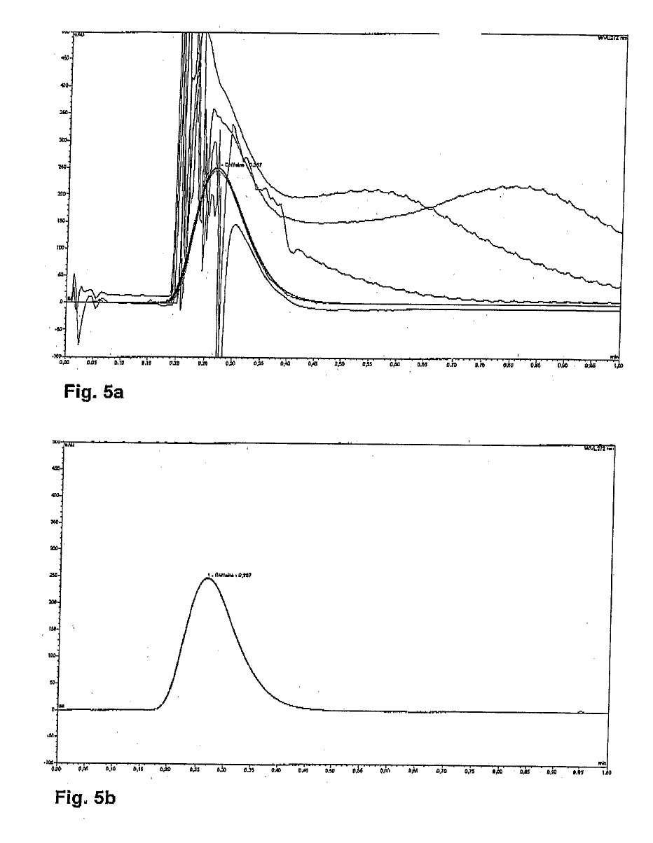

FIG. 4 shows a schematic side view of an individual sample container housed in a receiving unit;

FIG. 5a shows a chromatogram in the case of sample liquid containing gas bubbles; and

FIG. 5b shows a chromatogram in the case of sample liquid containing no gas bubbles.

FIG. 3 shows a considerably enlarged plan view of a schematic cross section through sampling needle 6 in the area of a septum 71 of a closure for a sample container 7 or 75, into which sampling needle 6 is inserted to withdraw a sample volume or liquid volume. FIG. 3 shows the condition that results if, after insertion of the sampling needle into the flexible material of septum 71 according to FIG. 2 or of bubble 761 of a bubble sheet 76 according to FIG. 2a, such a relative movement of the receiving unit for the individual or multiple sample container 7 or 75, respectively, is performed in a direction substantially perpendicular to the longitudinal axis of the sampling needle (the arrow in FIG. 3 illustrates a movement of sampling needle 6 relative to septum 7 or the bubble 761 in question). With a sufficiently large movement path (as viewed in the direction of motion of the sampling needle) behind sampling needle 6, a roughly crescent-shaped opening 9 in the flexible material of septum 71 or of bubble 761 results, through which ambient air can flow into the interior of sample container 7 or 75. A pressure equalization is thereby achieved between the interior of container 7 or 75 and the surroundings.

In order to perform the displacement according to the invention, the existing hardware of the conventional autosampler represented in FIG. 1 can be used, since it is designed to move to several different sample containers, and thus enables a movement perpendicular to the axis of sampling needle 6.

Due to the pressure equalization that becomes possible in this manner, the predetermined volume of liquid can be withdrawn, without restrictions existing regarding the fill level of the sample containers, the withdrawal volume or the withdrawal rate. The withdrawal rate is limited only by the flow resistance of the fluid components that are involved.

No additional components in comparison with known autosamplers are required to perform the method according to the invention, since the mechanism in the autosampler that is required for the displacement must in any case be present in the autosampler in order to be able to collect different samples at all. Only a sufficient elasticity on the part of the septum for the sample container is necessary to apply the method. In any case, this elasticity is necessary in practice however, so that the septum can fulfill its task, namely, tightly re-closing the sample container after withdrawal of the liquid volume.

Accordingly, the method according to the invention can be used for any desired autosamplers and septa, including existing ones, without a significant additional expense arising. Only the control software or the firmware of the autosampler need be adapted in such a manner that the displacement can be performed at the proper time.

If the sampling needle does not have sufficient stability, it can be easily exchanged for a correspondingly more stable needle.

The displacement path must be dimensioned such that a sufficiently large opening 9 can be achieved. An unnecessary bending of sampling needle 6 should also be avoided. Therefore the displacement path must be optimized, taking into account the influencing factors below.

Septum 71 or a bubble 761 of a bubble sheet 76 first deforms over a large area due to the displacement before an opening 9 results at all. This must be taken into consideration in establishing the displacement path. It must also be taken into account that individual sample containers 7 or multiple sample containers 75 (well plates) typically have play in their holder in receiving unit 10, so that they can yield or tilt away somewhat due to the displacement. Moreover, the force exerted on sampling needle 6 leads to a bending of the needle.

These influences are shown greatly exaggerated in FIG. 4 for the sake of example. Sample container 7 is tilted due to the displacement in recess 771 of receiving unit 10, and sampling needle 6 is bent relative to its holder 61.

This can be compensated by enlarging the displacement relative to the original value for generating crescent-shaped opening 9. The actually necessary displacement can easily be determined experimentally. For this purpose, it is only necessary to conduct tests for different displacement paths with sample containers filled as completely as possible and with large withdrawal volumes. Whether the displacement is sufficient for achieving the effect according to the invention can easily be recognized by evaluating the chromatograms, as will be demonstrated below.

If ordinary autosamplers, sampling needles, sample containers and septa on the market are used, displacements on the order of 1-2 mm are generally practical. Depending on the construction of the components, smaller or larger displacements in the range of 0.1 to 5 mm can be necessary.

The pressure equalization need not be enabled in every case before the beginning of the withdrawal process for the liquid volume. Before the start of the withdrawal process, sampling needle 6 penetrates through septum 71 or bubble 761. Septum 71 or bubble 761 bends downward in the process. Due to the friction between sampling needle 6 and septum 71 or bubble 761, this bending is maintained even after the penetration, and consequently causes a positive pressure due to the diminution of the interior space of the container. The volume displaced by sampling needle 6 likewise leads to a positive pressure. This positive pressure can certainly be desirable, since it eases the withdrawal of the liquid volume.

The opening 9 produced by this displacement according to the invention would lead to a premature depletion of this overpressure. In order to avoid this, it can be expedient not to perform the displacement immediately after the puncturing of the septum, but to wait until shortly after the beginning of the withdrawal process, when just enough volume has been drawn off that the positive pressure has already been reduced.

The effectiveness of the method according to the invention was checked on the basis of chromatographic measurements. If negative pressure problems such as gas bubbles occur during the withdrawal of the sample, this first leads to a change in the amount of injected sample and thus in the chromatographic peak surface areas, and in case of larger bubbles, to heavily falsified, non-analyzable chromatograms.

Therefore a defined amount of caffeine was injected with an autosampler in each case and the signal profile in the detector was analyzed. The sample containers were each nearly completely filled.

FIG. 5a shows the chromatograms of 11 successive measurements, each without allowing a pressure equalization. In some cases, markedly differing signal curves result, which indicates aspirated air, the formation of gas bubbles and the injection of both. Such measurement results would be unusable for common automatic analysis methods.

FIG. 5b likewise shows 11 chromatograms that were recorded under conditions identical to those in FIG. 5a, but allowing a pressure equalization, as described above. The curves obtained now correspond to the expected profile and all lie exactly one atop the other. Consequently, a very good chromatographic reproducibility and measurement precision is achieved.

Additional measurements have shown that without allowing a pressure equalization, the withdrawal rate would have to be extended by a factor of 10 in order to achieve similarly good results.

These results show that a substantial improvement of the performance capabilities of the autosampler can be achieved by using the invention.

1. Method for drawing a volume of liquid, in particular for collecting a sample for analysis by means of a liquid chromatography device
(a) wherein the liquid comprising the liquid volume to be withdrawn is provided in a container (7, 75),
(b) which is closed off by means of a closure (72, 71; 76, 761) that consists in at least one partial area of a flexible material that can be penetrated by a sampling needle,
(c) wherein sampling needle (6) is punched through the partial area consisting of a flexible material for drawing a defined volume of liquid, until the suction opening of the sampling needle is immersed sufficiently deep into the liquid, and
(d) wherein a defined liquid volume is withdrawn, characterized in that
(e) to avoid a negative pressure arising from the withdrawal of the liquid volume in container (7, 75), a relative movement is effected between sampling needle (6) and container (7, 75) in a direction substantially perpendicular to the longitudinal axis of sampling needle (6),
(f) such that the opening (9) produced in the flexible material of closure (72, 71; 76, 761) by the puncturing of the flexible material is expanded in such a manner that a complete or partial pressure equalization between the container volume and the surroundings is made possible between the outer wall of sampling needle (6) and the inner wall of the expanded opening (9).

2. Method according to claim 1, characterized in that container (7, 75) and sampling needle (6) are moved relative to one another in a direction substantially perpendicular to the longitudinal axis of sampling needle (6).

3. Method according to claim 1 or 2, characterized in that the pressure equalization due to the performance of the relative movement becomes possible only if a predetermined threshold value for the absolute value of the pressure difference between the container volume and the surroundings is present or is detected.

4. Method according to one of the preceding claims, characterized in that the pressure equalization due to the performance of the relative movement is enabled only after a predetermined span of time following the start of the withdrawal, or after the withdrawal of a predetermined partial volume.

5. Method according to one of the preceding claims, characterized in that a volume diminution of the interior of the container (7, 75) is effected when the flexible material is penetrated, and the pressure equalization due to the performance of the relative movement is effected only if a partial volume corresponding to the volume diminution has been withdrawn.

6. Device for drawing liquid volume, in particular for collecting and supplying a sample to a liquid chromatography device,
(a) with a receiving unit (10) for receiving at least one container (7, 75) in which the liquid comprising the liquid volume to be removed is held,
(b) wherein container (7, 75) is closed off by means of a closure (7, 75; 72, 761) that consists in at least one partial area of a flexible material that can be penetrated by means of a sampling needle,
(c) with a drive mechanism for moving sampling needle (6) and/or moving receiving unit (10) substantially in the direction of the longitudinal axis of sampling needle (6),
(d) with a drive mechanism for moving receiving unit (10) and/or with a drive for moving sampling needle (6) in a plane substantially perpendicular to the longitudinal axis of sampling needle (6) and
(e) with a control unit (12) for controlling the drive mechanisms, wherein control unit (12) controls the drive mechanisms such that
(i) by first effecting a relative movement between receiving unit (10) and sampling needle (6) in a plane substantially perpendicular to the longitudinal axis of sampling needle (6), sampling needle (6) is positioned with its tip over the area of the container's closure (72, 71; 76, 761) made of flexible material, and
(ii) subsequently sampling needle (6) is punched through the partial area consisting of flexible material by effecting an axial relative movement between receiving unit (10) and sampling needle (6) until the suction opening of the sampling needle is immersed sufficiently into the liquid, and
(f) wherein the control unit subsequently activates a suction device (4) for drawing the liquid volume to be withdrawn
characterized in that
(g) after the puncturing of the area made of a flexible material, control unit (12) controls the drive or drives to produce a relative movement between sampling needle (6) and receiving unit (10) in a plane substantially perpendicular to the longitudinal axis of sampling needle (6) in such a manner that
(i) the opening in the flexible material of the closure produced by the puncturing of the flexible material is expanded in such a manner that a complete or partial pressure equalization between the container volume and the surroundings is made possible between the outer wall of the sampling needle and the inner wall of expanded opening (9).

7. Device according to claim 6, characterized in that container (75) has several receiving volumes (751), each for a liquid, and in that the openings of the receiving volumes can be closed off by means of a common closure means (76).

8. Device according to claim 6, characterized in that the closure means is a bubble sheet or bubble plate (76) or comprises one, wherein a respective bubble (761) of bubble sheet or bubble plate (76) reaches into an opening of a receiving volume (751) to be closed off and closes it off.

9. Device according to one of claims 6-8, characterized in that control unit (12) controls the drive mechanism or mechanisms to produce a relative movement between sampling needle (6) and receiving unit (10) in a plane substantially perpendicular to the longitudinal axis of sampling needle (6) in such a manner that the method according to one of claims 2-5 is performed.

10. Control unit according to one of claims 6-9, characterized in that control unit (12) comprises a microprocessor circuit for controlling the drive mechanisms for sampling needle (6) and receiving unit (10), as well as software or firmware therefor.

11. Software or firmware for a control unit according to claim 10, recorded on a data medium.
